(19) United States
(12) Patent Application Publication
(10) Pub. No.: US 2026/0296354 A1
(43) Pub. Date: Oct. 1, 2026

(54) VEHICLE HAVING A RESTRAINT DEVICE

(71) Applicant: AUTOLIV DEVELOPMENT AB, Vargada (SE)

(72) Inventors: Hakan SUNDMARK, Alingsas (SE); Johan FRITZEN, Vargarda (SE); Christer LUNDGREN, Vargarda (SE); Mattias ENNERDAL, München (DE); Thomas WOHLLEBE, Calberlah (DE)

(21) Appl. No.: 19/480,699

(22) PCT Filed: Apr. 30, 2024
(86) PCT No.: PCT/EP2024/061880

§ 371 Date: Oct. 31, 2025

(30) Foreign Application Priority Data
May 2, 2023 (DE) 10 2023 111 330.5

(51) Int. Cl. B60R 21/231; B60R 21/00; B60R 21/16; B60R 21/2165; B60R 21/26

(52) U.S. Cl. CPC B60R 21/231; B60R 21/2165; B60R 2021/0034; B60R 2021/161; B60R 21/26

(57) ABSTRACT

The invention relates to a vehicle having a restraint device for securing a person situated on a lying device of the vehicle, wherein the restraint device has at least one upper-body airbag arranged in an upper-body portion of the lying device. Especially, at least one upper-body airbag is arranged in each of the two longitudinal side regions of the lying device, wherein, in a release state, at least part of each upper-body airbag extends, starting from the side regions, transversely over the lying surface of the upper-body portion, and these upper-body airbags bear with at least some portion thereof against one another.

The invention relates to a vehicle having a restraint device for securing a person situated on a lying device of the vehicle, wherein the restraint device comprises at least one upper-body airbag arranged in an upper-body portion of the lying device.

In the event of an accident, a vehicle is decelerated significantly. An occupant sitting inside the vehicle can participate in this deceleration in the well-known, conventional manner by being strapped in by a seat belt and usually also via airbags and, as a result of being secured, they are largely prevented from being dislodged from their seat despite their inertia. This means that the occupant is substantially safely positioned in their seat.

In motor vehicles, various active and passive safety systems traditionally ensure the safety of the motor vehicle's occupants as far as possible. Seat belts, which may be equipped with active belt tensioners, as well as airbags which protect an occupant from the front and, if necessary, from the sides, are often considered to be such safety systems. These safety systems have generally proven to be effective.

Nevertheless, even with such conventional safety systems, there is a constant effort to increase occupant safety. For example, EP 2 360 067 A2 describes a restraint system for vehicle occupants comprising a belt and an airbag unit that comprises an airbag and is arranged on the belt, designed to position the airbag as close as possible to the body regions of the vehicle occupant to be protected, such as the head, even in its original position. The belt and the airbag unit are designed to be movable relative to one another in order to enable precise positioning of the releasing airbag in the event of an accident.

The use of such conventional safety systems is also known in the field of autonomous vehicles, which are at least optionally self-driving. In this regard, DE 10 2022 113 775 A1 describes an autonomous motor vehicle which allows the occupants in the front and rear vehicle seats to sit facing one another in a conventional, upright position during vehicle operation, with the occupants being secured in the vehicle seats by seat belts. The vehicle seats are arranged in the cabin of the motor vehicle so as to be rotatable and movable in order to enable occupants to sit facing one another. To provide lateral protection for the occupants, an airbag is arranged on the outside between each vehicle seat and the vehicle body. When deployed, this airbag extends along the vehicle seat from the floor to the roof of the vehicle. In order to be able to follow the position of each vehicle seat during movement, an airbag assembly containing the airbag is also mounted so that it can move along a guide arranged on the floor of the motor vehicle.

However, the disadvantages of conventional safety systems, such as seat belts and airbags, generally lie in the fact that they are usually designed such that only occupants in an upright or at least almost upright sitting position can be secured. This applies in particular to a conventional seat belt, which in principle only functions optimally when the occupant's upper body is moving in the direction of the impact and is substantially upright. Airbags arranged in the passenger-side dashboard for restraining the head and upper body can also cause serious injuries if the occupant is positioned in an unintended position in the vehicle, for example with their legs resting on the dashboard.

In autonomous vehicles, however, every occupant can generally spend the journey in any way they wish. This could include, for example, reading, using visual media, resting or sleeping. For increased comfort, it is therefore sensible for occupants to also be able to spend the journey in a lying position, allowing an occupant to sleep comfortably. As previously described, while conventional safety systems are suitable when an occupant is sat in an upright position, they are ineffective, or only partially effective, for occupants lying down.

However, proposed solutions addressing this problem are already known from the prior art.

In this respect, DE 10 2019 115 254 A1 describes an inflatable safety blanket, which also serves to protect a motor vehicle occupant who, among other things, is situated in a lying position. The safety blanket has an airbag arranged between a first blanket layer and a second blanket layer connected to the first blanket layer. The airbag also has a plurality of independently inflatable chambers that are thus separated from one another so that fluids cannot pass through. These chambers cover different regions of the occupant, such as the legs, the pelvic region and the upper body, and therefore have different pressures when inflated. It is also possible for the inflatable safety blanket having the chambers to be customized for the occupant based on biometric data. These biometric data may include, among others, the occupant's weight, height, upper-body height and/or leg length. These biometric data can be provided upon purchase of the vehicle, and the safety blanket can be individually tailored to the occupant. Other possible ways to capture biometric data include using a camera sensor and then analyzing the images to obtain the necessary information. In addition, the safety blanket may include a main portion and a head protection portion to protect the occupant's head. In the non-deployed state, the head protection portion is concealed in an upper portion of the first blanket layer and the second blanket layer facing the occupant's head and only extends over the occupant's head when the airbag is deployed. The head protection portion can be formed, on the one hand, by a head protection chamber of the airbag, which can inflate independently of the rest of the airbag, i.e. independently of the main portion. On the other hand, the head protection portion can be formed, instead of by an airbag chamber, by an independent head protection airbag, which can inflate independently of the main airbag.

The above-mentioned solution for transporting occupants lying down can only ensure the safety of occupants situated in a lying position with a low level of comfort. The disadvantage is that the occupant is always covered to a very large extent, i.e. including the upper body and in particular the arms, by the safety blanket described during transport. This is quite uncomfortable even for an occupant who is sleeping, and especially for an occupant who wishes to carry out other activities. Furthermore, these solutions only protect occupants transported in particular lengthwise from sliding by the friction between the safety blanket and the occupant, which represents an insufficient level of safety.

Against this background, the object addressed by the invention is that of designing a vehicle having a restraint device of the type mentioned at the outset such that the safety of a person situated in a lying position in the vehicle is improved while providing increased comfort.

This object is achieved by a vehicle according to the features of claim 1. The dependent claims relate to particularly expedient developments of the invention.

According to the invention, a vehicle, in this case preferably a land vehicle, particularly preferably a passenger car, is thus provided with a restraint device for securing a person, in particular situated in a lying or strongly inclined position, on a lying device of the vehicle. The restraint device has at least one upper-body airbag arranged in an upper-body portion of the lying device.

The upper-body portion in which the upper-body airbag is arranged is therefore the portion of the lying device in which the upper body of the person situated in a lying position on the lying device is substantially positioned. The portion can be predetermined, for example, using the measurements of the 5th percentile woman and/or the 95th percentile man. It is also conceivable that the lying device is individually adapted to the person using the lying device so that the upper body of the person is situated in the upper body portion. In principle, the upper body portion approximately encompasses the head-end third of the lying device or is situated in this third.

In particular, according to the invention, at least one upper-body airbag is even arranged in each of the two longitudinal side regions of the lying device, wherein, in a release state, at least part of each upper-body airbag, in particular of the upper-body airbag(s), extends—at least temporarily—transversely over the lying surface of the upper-body portion starting from the side regions. These upper-body airbags, at least two of which originate from different side regions, bear with at least some portion thereof against one another. The upper-body airbags are situated in the same longitudinal position in the upper-body portion of the lying device and/or are preferably in a state of maximum deployment in the release state. The restraint of the person, in this case in the upper body region, is achieved primarily through frictional forces, i.e. the friction between the upper-body airbags and the person, as well as between the person and the lying device.

The design of the upper-body airbags offers the fundamental advantage that the upper body, including the arms of the person, for example, can remain so as not to be covered by additional restraint systems such as a cover element in the form of a safety blanket, and such a cover element only extends, for example, from the base of the lower legs to the pelvis of the person. This increases the comfort of the person on the lying device, as their mobility is largely maintained. In addition, the arrangement in the side region of the lying device, in particular compared to an arrangement on or in a vehicle structure facing the lying surface of the lying device, for example situated above the lying device, has the advantage that the person can be provided with significantly greater freedom of movement and short deployment times until the upper-body airbags are fully deployed can be ensured. However, if the airbags are arranged on or in a vehicle structure facing the lying surface of the lying device, a short distance from the vehicle structure would be required to ensure a small volume and thus a short deployment time, or it would be necessary to accept an increased deployment time, which would, however, reduce the person's safety. Furthermore, this design of the upper-body airbags effectively contributes to ensuring that, in the direction normal to the lying surface of the lying device, in particular along the vertical axis of the vehicle, the person is pressed or held in the direction of the lying device over a large surface in the event of an accident. In the longitudinal direction of the lying device, an objective can also be to clamp the upper body of the person using, in particular, the two upper-body airbags.

In this way, the safety of the person situated in a lying position on the lying device of the vehicle is significantly improved while also providing increased comfort.

One possibility for improving the restraint of the person on the lying device, in particular by increasing friction, is to design the upper-body airbags with at least one main chamber and at least one secondary chamber. In a development, the main chamber and the secondary chamber are connected to one another in a fluidic and/or fluid-permeable manner via at least one overflow opening. In this case, each secondary chamber is arranged on a main chamber such that, in the release state of the upper-body airbag, it is shaped to face the lying surface. The secondary chamber preferably has a smaller volume than the main chamber and extends—in the release state-substantially over the entire width of the main chamber in the longitudinal direction of the lying device. Thus, the secondary chamber has a rather elongated configuration. By designing the upper-body airbags to comprise the two chambers, i.e. the main and secondary chambers, the person's upper body is largely homogeneously encircled, whereby high normal forces and consequently also high frictional forces act on the upper body.

In an advantageous development of the invention, the upper-body airbags are also each pivotable about an axis that is parallel to the longitudinal direction of the lying device and/or toward and/or away from the lying device by means of an airbag unit, which is pivotally connected to the lying device in particular in the longitudinal side regions of the lying device. In this way, the airbag unit is advantageously pivotable between different positions on or opposite the lying device in order to provide different functional states of the upper-body airbags in these positions. The airbag units can be arranged in side structures, in particular those formed over the entire length of the lying device, for example side bolsters or side boxes, or can be formed by these side structures.

In this context, as well as in general, it is advantageous if each airbag unit is pivotable via an actuator. Reversible and/or irreversible pivoting or positioning of the airbag unit can advantageously be achieved via an actuator. The actuator can be, for example, a pyrotechnic, pneumatic or electric actuator. A combination is also conceivable, for example a design of the actuator comprising a reversible and an irreversible stage, wherein such an actuator would be designed, for example, as an electric and pyrotechnic actuator.

It is also advantageous if the airbag units comprising the upper-body airbags are pivotable at least between a release position and a contact position, wherein, in the release position, each airbag unit is arranged in a pivoted position along the longitudinal side of the lying device, in particular laterally of a support structure of the lying device. An exit region of the upper-body airbag from the airbag unit is preferably directed toward a lying side of the lying device. Because the airbag unit is pivotable between the release position and the contact position, the upper-body airbags can be extremely advantageously transferred into their release position by initially deploying them in their release position. This prevents any incorrect deployment due to a collision with vehicle structures and/or the person, and ensures the intended positioning of the upper-body airbags in their intended shape on the person. The upper-body airbags are preferably transferred from a non-use state, which also exists in the release position, in particular in non-critical driving situations, into the release state. In the release state, the upper-body airbags then apply high internal pressure to the person situated on the lying device. The release position can also correspond to the basic installation position when the airbag units are not in use, in particular in non-critical driving situations, so that the airbag units would also only be pivotable between the two positions: the release position and contact position, and the release position would thus also correspond to a non-use position.

The size of the pivot angle of the airbag units and/or the upper-body airbags between the release position and the contact position can also be adaptively adjusted to the upper-body circumference or chest circumference of the person situated on the lying device. For persons with a small upper body circumference, the pivot angle in the direction of the lying device is greater than for persons with a large upper body circumference.

The invention is also advantageously characterized in that the airbag units comprising the upper-body airbags are also pivotable between a non-use position and the release position. Further developing this, it can be provided that, in the non-use position, each airbag unit is arranged in a pivoted position on an underside of the lying device that is opposite the lying side, in particular an underside of a support structure of the lying device. In addition, in a further embodiment of the development, each airbag unit can be covered from the lying side by the support structure of the lying device. The upper-body airbags are accordingly also in their non-use state in the non-use position. In this case, an exit region, from which the upper-body airbags exit the airbag units when transitioning into the release state, preferably faces away from a base frame of the lying device and is directed in particular in a direction that is parallel to the lying surface of the lying device. This allows the airbag units to be advantageously only pivoted from the non-use position into the release position in a critical driving situation, e.g. released by a control unit that has detected a potential accident. By keeping the airbag units in the least disruptive non-use position, the freedom of movement for the person when it is not in use can thus be increased and/or the aesthetic appearance of the lying device can thus be improved.

It is also extremely advantageous if the upper-body airbags are transferred into their release state in the contact position and, in the contact position, the airbag units containing the upper-body airbags are arranged in a pivoted position which is pivoted further in the direction of the lying side of the lying device compared to the release position so that a force exerted on the person by the upper-body airbags in the contact position is increased compared to a force exerted on the person in the release position by the upper-body airbags that are in the release state. The increased force, in particular a contact force or normal force, advantageously results in a further improvement in terms of restraining the person situated on the lying device, since, as already explained, the person is restrained substantially through frictional forces, i.e. the friction between the upper-body airbags and the person as well as between the person and the lying device.

In an advantageous embodiment of the invention, it is further conceived that an opening or a weakened portion, in particular a predetermined breaking point or tear point, is formed in an in particular planar, preferably pliable, upholstery element of the lying device, which in this case is aligned in particular with the exit region of the airbag units that are in the release position. Developing this embodiment further, an opening can be formed from the weakened portion by the upper-body airbag of the airbag unit transitioning into its release state. In a further development, it is conceived that the upper-body airbag of the airbag unit aligned with the opening or weakened portion passes through the opening in the release state. Thus, the upper-body airbags can advantageously transition or be transferred into the release state even though they are covered with the upholstery element, in particular edge regions of the upholstery element, for example to provide a continuous lying surface for the person, to improve the aesthetic appearance and/or to reduce the risk of injury to the person situated on the lying device.

The vehicle according to the invention, and in particular the restraint device, offers the possibility of integrating an inflator into the airbag unit, in addition to the upper-body airbag, which fills the upper-body airbag with gas for deployment, and this thus being pivotally connected and/or pivotable together with the upper-body airbag or the airbag unit.

In another, but equally advantageous, design, an inflator for filling at least one of the upper-body airbags with a gas that deploys the upper-body airbag is also arranged in a fixed position on the lying device, in particular a base frame of the lying device, and is connected to the upper-body airbag in a fluidic and/or fluid-permeable manner via at least one gas line. Compared to when said inflator is integrated into the airbag unit, this reduces the mass of the airbag units that has to be moved during pivoting. This allows, in particular, for shorter pivoting times and/or a lower performance actuator to be used. The gas line can be, for example, a filling hose or a gas lance.

Furthermore, it is also advantageous if a longitudinal edge region of an in particular planar, preferably pliable, upholstery element of the lying device covers the exit region of airbag units that are in the release position, in particular lying flat. Thus, as already explained, a continuous lying surface can be provided for the person, the aesthetic appearance of the lying device can be improved and/or the risk of injury to the person situated on the lying device can be reduced.

In order to be able to ensure the safety of the person despite the upholstery element being designed without an opening and/or a predetermined tear or breaking point, a development of the invention advantageously provides that the edge region of the upholstery element covering the exit region is transferred, in particular folded over, onto a central region of the upholstery element in the release state and/or the contact position by the transition of an upper-body airbag into its release state and/or the pivoting of the airbag unit containing the upper-body airbag into the contact position, in particular forming a bulge. This can further increase the force in particular acting laterally on the person, in this case the contact or normal force. The central region covers, in particular, the support structure, preferably the support surface of the support structure of the lying device.

In general, but in particular in the above context, it is also advantageous if a weakened portion is formed in the upholstery element at a transition from the edge region to the central region of the upholstery element, in particular one that extends over the entire length of the upholstery element and/or forms a flexure bearing. This simplifies the transfer of the edge regions of the upholstery element to the central region. The weakened portion in principle forms a flexure bearing, wherein the weakened portion can be designed, for example, as a tapered portion or as a region with a lower filling density of the upholstery element.

In a development of the invention, the lying device also comprises a flexible, in particular pliable and/or tensile-resistant, planar cover element which, in a use position of the cover element, covers at least part, but preferably only part of the body surface of the person. The cover element is a blanket, preferably a safety blanket or restraint blanket.

Furthermore, in one embodiment of the invention, it is envisaged that the restraint device has a pelvic airbag arranged in a thigh and/or pelvic portion of the lying device, via which, in a release state of the pelvic airbag, a lying surface of the lying device is formed at least in some regions—in the thigh and/or pelvic portion-opposite the interior of the lying device, in particular at least temporarily, i.e. projecting outwards. The lying surface is therefore formed in the direction of the cover element that is in the use position. In the release state, the pelvic airbag is preferably in a state of maximum deployment.

The thigh and/or pelvic portion in which the pelvic airbag is arranged is accordingly the portion of the lying device in which a transition region between the thigh and pelvis of the person situated in a lying position on the lying device is substantially positioned. This portion can in turn be predetermined by the measurements of the 5th percentile woman and/or the 95th percentile man. It is also in turn conceivable that the lying device is individually adapted to the person using the lying device so that the transition region between the thigh and pelvis of the person is situated in the thigh and/or pelvic portion. In principle, the thigh and/or pelvic portion approximately encompasses the middle third of the lying device or is situated within this third.

It is also advantageous if a zone of variable stiffness and/or hardness is formed in the upper-body portion within the lying device. This can thus minimize or even prevent the upper body of the person from sinking into the lying device while also generating a potentially additional force, in particular on the upper body of the person, from the rear side. This advantageously leads to a better fit of the upper-body airbags and/or the cover element against the person.

It is also considered advantageous if the zone of variable stiffness and/or hardness is formed by a stiffening device and/or a material with variable stiffness and/or hardness. If the stiffening device is designed as a stiffening airbag, this results in a structurally advantageous, simple design of the stiffening device, which is also consistent with the arrangement of other airbags, such as the upper-body airbags and the pelvic airbag, thus implementing a holistic concept. This enables, for example, uniform control and a simplified supply chain.

Furthermore, it may be provided that a footrest, in particular one designed to be movable relative to the lying device, is arranged on the lying device at the foot end. The footrest and the lying device can also be connected to one another via an energy absorption element, for example a damping element and/or deformation element.

Likewise, it is also possible for the lying device to be movably arranged on a base frame, in particular a chassis and/or a body of the vehicle, in particular a passenger car. The lying device and the base frame can also be coupled or connected to one another via at least one energy absorption element, for example a damping element and/or deformation element.

The invention allows for numerous embodiments. To further clarify its basic principle, several of them are shown in the drawings and described below. In the drawings:

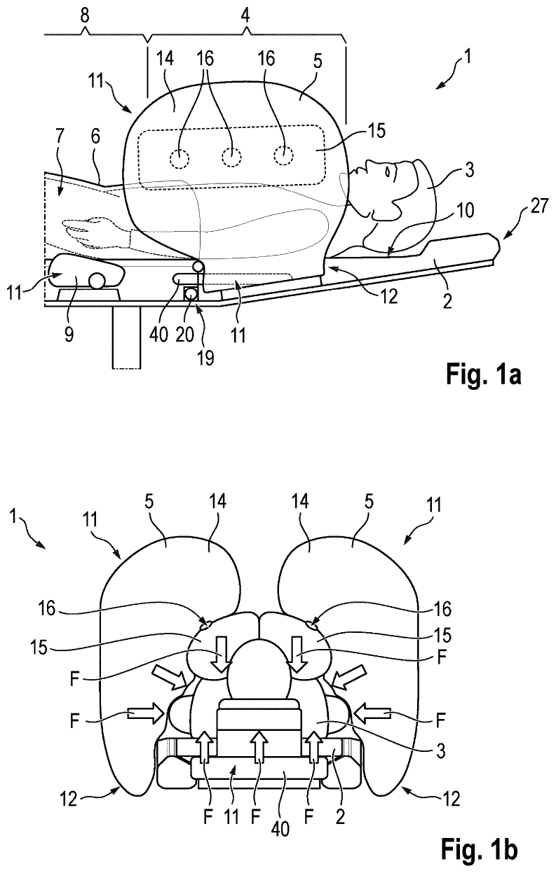

FIG. 1a, 1b show a development of a restraint device according to the invention;

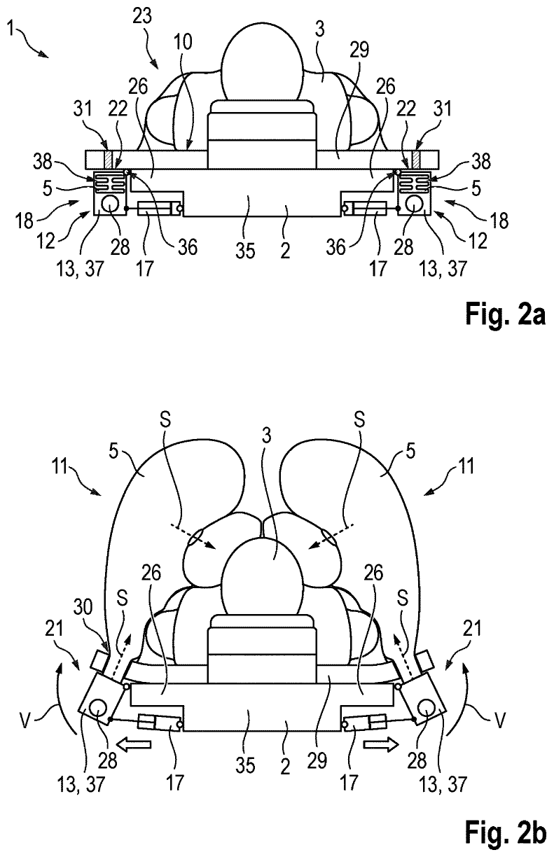

FIG. 2a, 2b show an embodiment of the restraint device having an opening that can be formed via a weakened portion in the upholstery element;

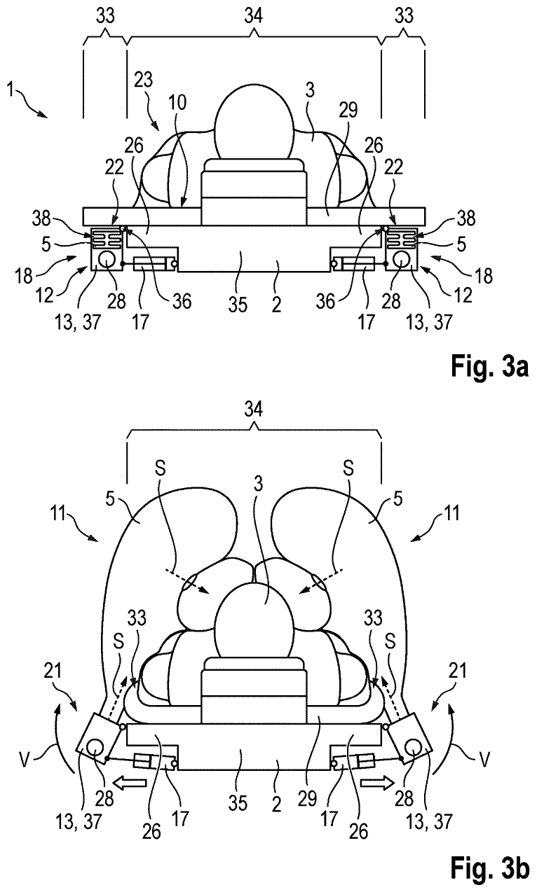

FIG. 3a, 3b show an embodiment of the restraint device having edge regions of the upholstery element transferred to the central region of the upholstery element;

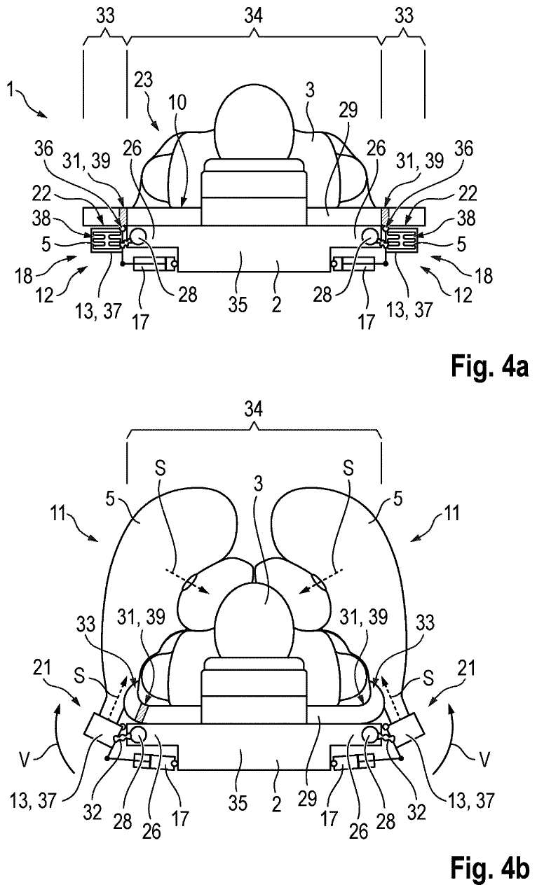

FIG. 4a, 4b show an embodiment of the restraint device having an immovable inflator;

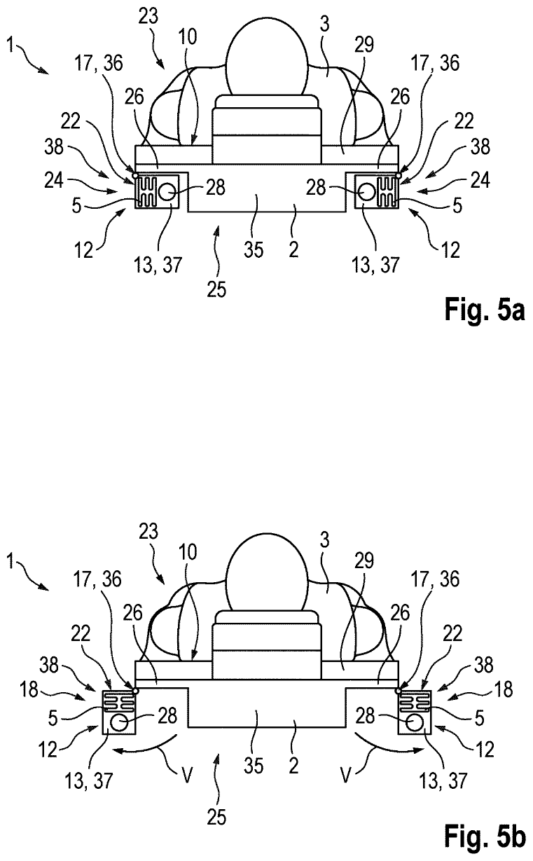

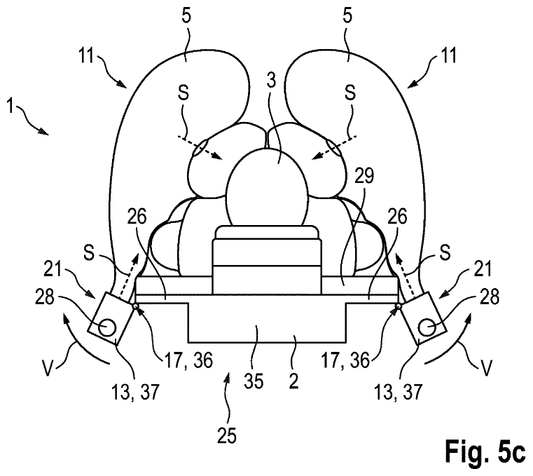

FIGS. 5a to 5c show an embodiment of the restraint device having airbag units that can pivot from a non-use position.

FIGS. 1a and 1b show a development of the restraint device 1 according to the invention for arrangement in a vehicle (not shown in detail). The restraint device 1 serves to secure the person 3 situated on the lying device 2. For this purpose, the restraint device 1 has two upper-body airbags 5 arranged in the upper-body portion 4 of the lying device 2. In particular, each of the upper-body airbags 5 is arranged in one of the two longitudinal side regions 12 of the lying device 2. As shown again in a plan view in FIG. 1b, the upper-body airbags 5, which are in the release state 11 and arranged in the two longitudinal side regions 12 of the lying device 2, partially extend, starting from the side regions 12, transversely over the lying surface 10 of the upper-body portion 4.

In addition, the restraint device 1 has the flexible, pliable and flat cover element 6, which is designed as a restraint blanket. In the use position 7 of the cover element 6 shown in FIGS. 1 and 2, the cover element 6 covers only part of the body surface of the person 3 in order to enable the person 3 to lie as comfortably as possible on the lying device 2. In the illustrated use position 7, the cover element 6 is also connected to the lying device 2 at three connection points 19 in each of the two longitudinal side regions 12 of the lying device 2, wherein only a first connection point 19 is shown in FIG. 1a. The connection of the cover element 6 to the lying device 2 is carried out in particular via a connecting element 20 for each connection point 19, wherein the connecting element 20 shown in FIG. 1a is designed as a combination of a force limiter and tensioner for the cover element 6. Further connection points 19 include connecting elements 20, which are designed solely as force limiters or as fixed connectors.

Furthermore, in this development, the restraint device 1 comprises the pelvic airbag 9 arranged in the thigh and/or pelvic portion 8 in the center of the lying device 2, which is also in the release state 11 in the illustration in FIG. 1a. The pelvic airbag 9 serves, on the one hand, to pivot the thighs of the person 3 upward to cause the knees to bend if, in an accident, the person 3 is displaced forward relative to the lying device 2, opposite the head end 27 of the lying device 2. On the other hand, the pelvic airbag 9 also forms a kind of wedge or ramp under the pelvis of the person 3 as they move on the lying device 2, thereby moving the person 3 into the cover element 6. The increased form fit between the person 3 and the cover element 6, resulting from the pelvic airbag 9 acting as a ramp and also from the effect of the bent legs, and/or the force exerted by the cover element 6 on the person 3, significantly increase(s) the degree to which the person 3 is restrained by the cover element 6.

As can also be seen from FIGS. 1a and 1b, the upper-body airbags 5 each comprise the main chamber 14 and the secondary chamber 15, wherein the main chamber 14 and the secondary chamber 15 are connected in a fluid-permeable manner via a plurality of, here specifically three, overflow openings 16. Each secondary chamber 15 is also arranged on the main chamber 14 such that, in the release state 11, it is shaped to face the lying surface 10. The secondary chambers 15 have a smaller volume than the main chambers 14 and extend over almost the entire width of the main chambers 14 in the longitudinal direction of the lying device 2 and thus have a rather elongated configuration.

In this development, the upper-body airbags 5 are further configured by means of the secondary chambers 15 such that they also assume the role of restraining the head of the person 3, as shown in particular in FIG. 1b. Furthermore, the design of the upper-body airbags 5 comprising the main chamber 14 and the secondary chamber 15 achieves homogeneous encirclement of the upper body of the person 3, wherein the upper-body airbags 5 and the secondary chambers 15 bear with at least some portion thereof against one another and thus exert high normal forces F on the upper body of the person 3.

The normal forces F acting on the person 3 can also be increased by the stiffening airbag 40 integrated in the upper-body portion 4 of the lying device 2. In particular, the stiffening airbag 40, which is in the release state 11, can minimize or even prevent the upper body of the person 3 from sinking into the lying device 2, while also generating additional normal forces F on the upper body of the person 3 from the rear side. This improves the fit of the upper-body airbags 5 and the cover element 6 against the person 3.

The other drawings, FIGS. 2a to 5c, henceforth show embodiments of restraint devices 1 in which the upper-body airbags 5 arranged in the side regions 12 of the lying device 2 are each pivotable via an airbag unit 13 which is pivotally connected to the support structure 26 of the base frame 35 of the lying device 2 by means of the pivot joint 36. In this case, each airbag unit 13 is in particular pivotable via an actuator 17, for which the actuators 17 are arranged partly connected to each airbag unit 13 and partly to the base frame 35 of the lying device 2. In the embodiment of FIGS. 5a to 5c, however, the actuator 17 is integrated into the pivot joint 36. Furthermore, the upholstery element 29 of the lying device 2, on which the person 3 is situated lying down on the lying surface 10, bears with at least some portion thereof on the support structure 26, in this case with at least some portion thereon in the embodiments of the restraint devices 1 shown in FIGS. 2a to 4b and completely thereon in the embodiment of the restraint device 1 shown in FIGS. 5a to 5c. Thus, in the embodiments shown in FIGS. 2a to 4b, the edge regions 33 of the upholstery element 29 project beyond the support structure 26, wherein the edge regions 33 also bear against the airbag units 13 which are in the release position 18 and are substantially aligned with the support structure 26 on the lying side 23 of the lying device 2. The airbag units 13 are designed by side bolsters 37 formed over the entire length of the lying device 2.

Furthermore, it can also be seen from FIGS. 2a to 5c that each of the airbag units 13 are pivotable between the release position 18 and the contact position 21. FIGS. 2a, 3a, 4a, and 5b show the airbag units 13 in their release position 18, in which the upper-body airbags 5 are in principle in the non-use state 38 shown and are therefore only deployed in the event of an accident, with which the upper-body airbags 5 transition into their release state 11 and, after deployment to the state of maximum deployment, are initially also in the release position 18 in the release state 11. In the release position 18, each airbag unit 13 is arranged in a pivoted position laterally of the support structure 26 of the lying device 2, wherein each exit region 22 of the upper-body airbags 5 from the airbag unit 13 is directed toward the lying side 23 of the lying device 2. The release position 18 in the embodiments shown in FIGS. 2a to 4b also corresponds to the basic installation position when the airbag units 13 are not in use, in particular also in non-critical driving situations in the vehicle (not shown in detail).

After transitioning to the release state 11 in the release position 18, with the upper-body airbags 5 then also already bearing against the person 3 in the release position 18, the airbag units 13 are pivoted into the contact position 21. After pivoting V into the contact position 21, the airbag units 13 are arranged in a pivoted position which is pivoted further in the direction of the lying side 23 of the lying device 2 compared to the release position 18. Pivoting V into the contact position 21 takes place with a time delay after the upper-body airbags 5 have been released in the release position 18, in order to ensure the correct positioning of the upper-body airbags 5 on the person 3. As a result of the pivoting V, the force exerted on the person 3 by the upper-body airbags 5 in the contact position 21, in this case the normal force F shown in FIG. 1b, is increased compared to the force, again the normal force F, exerted on the person 3 in the release position 18 by the upper-body airbags 5 located in the release state 11. Pivoting V from the release position 18 into the contact position 21 is indicated by arrows in FIGS. 2b and 3b, as well as 4b and 5c.

FIGS. 2a and 2b also show an embodiment of a restraint device 1 in which, as shown in FIG. 2a, a weakened portion 31 is formed in the upholstery element 29, which is aligned with the exit region 22 of the airbag units 13 that are in the release position 18. As the upper-body airbag 5 of each airbag unit 13 transitions into its release state 11, an opening 30 is formed from the weakened portion 31, which is designed as a predetermined tear point, by the deploying upper-body airbags 5 in the release position 18, wherein each of the upper-body airbags 5 pass through the openings 30 in the release state 11.

FIGS. 3a to 4b also show two embodiments of the restraint device 1 in which no openings 30 are provided that can be formed by transitioning the upper-body airbags 5 into their release state 11. In contrast, the two longitudinal edge regions 33 of the upholstery element 29, which cover each exit region 22 of the airbag units 13 that are in the release position 18, are transferred to or folded over onto the central region 34 of the upholstery element 29 by the upper-body airbags 5 transitioning into their release state 11 so that they form a bulge in the contact position 21 of the airbag units 13 and bear against the person 3. This can in particular further increase the force acting laterally on the person 3, in this case the normal force F shown in FIG. 1b. The central region 34 in particular covers the support structure 27.

In order to simplify the transfer of the two edge regions 33 to the central region 34, in the embodiment of the restraint device 1 shown in FIGS. 4a and 4b, the weakened portion 31 in the upholstery element 29 is also formed at each transition from the edge region 33 to the central region 34 of the upholstery element 29, forming a flexure bearing 39. In this embodiment, moreover, each inflator 28 for filling the upper-body airbags 5 with the gas that deploys the upper-body airbags 5 is arranged in a fixed position on the base frame 35, in this case the support structure 26 of the base frame 35 of the lying device 2, and is connected to the upper-body airbag 5 in a fluidic or fluid-permeable manner via the gas line 32. In comparison to the embodiments of the restraint devices 1 shown in FIGS. 2a to 3b and 5a to 5c, in which each inflator 28 for the upper-body airbags 5 is arranged with the upper-body airbags 5 within the airbag units 13, this reduces the mass of the airbag units 13 to be moved during pivoting V. The flow S of the gas that deploys the upper-body airbags 5 is indicated by arrows in FIGS. 2b and 3b, as well as 4b and 5c.

A further embodiment of the restraint device 1 is known from FIGS. 5a to 5c, in which the airbag units 13, in addition to being pivotable between the release position 18 and the contact position 21, are also pivotable between the non-use position 24 and the release position 18. In the non-use position 24, each airbag unit 13 is arranged in a pivoted position on the underside 25 of the support structure 26 of the lying device 2 that is opposite the lying side 23 and is covered by the support structure 26 from the lying side 23. In this case, the upper-body airbags 5 are in the non-use position 24 and accordingly also in their non-use state 38, wherein the exit region 22, facing away from the base frame 35, is directed in a direction that is parallel to the lying surface 10. This allows the airbag units 13 to be pivoted from the non-use position 24 into the release position 21, in particular only in a critical driving situation, released by a control unit that has detected a potential accident, and to be held in the non-use position 24 when not in use, thus minimizing disruption. Thus, the upholstery element 29 can also be flush with the support structure 26 and does not have to protrude beyond the support structure 26 in order to cover the airbag units 13. This also offers the advantage that the upper-body airbags 5 can deploy unhindered when transitioning into the release state 11.

List of reference signs

| | |
|---|---|
| 1 | Restraint device |
| 2 | Lying device |
| 3 | Person |
| 4 | Upper-body portion |
| 5 | Upper-body airbag |
| 6 | Cover element |
| 7 | Use position |
| 8 | Thigh and/or pelvic portion |
| 9 | Pelvic airbag |
| 10 | Lying surface |
| 11 | Release state |
| 12 | Side region |
| 13 | Airbag unit |
| 14 | Main chamber |
| 15 | Secondary chamber |
| 16 | Overflow opening |
| 17 | Actuator |
| 18 | Release position |
| 19 | Connection point |
| 20 | Connecting element |
| 21 | Contact position |
| 22 | Exit region |
| 23 | Lying side |
| 24 | Non-use position |
| 25 | Underside |
| 26 | Support structure |
| 27 | Head end |
| 28 | Inflator |
| 29 | Upholstery element |
| 30 | Opening |
| 31 | Weakened portion |
| 32 | Gas line |
| 33 | Edge region |
| 34 | Central region |
| 35 | Base frame |
| 36 | Pivot joint |
| 37 | Side bolster |
| 38 | Non-use state |
| 39 | Flexure bearing |
| 40 | Stiffening airbag |
| F | Normal force |
| S | Flow |
| V | Pivoting |

1. A vehicle having a restraint device for securing a person situated on a lying device of the vehicle, the restraint device having at least one upper-body airbag arranged in an upper-body portion of the lying device, characterized-in-that at least one upper-body airbag is arranged in each of the two longitudinal side regions of the lying device, at least part of each upper-body airbag extending, starting from the side regions, transversely over the lying surface of the upper-body portion in a release state, and these upper-body airbags bearing with at least some portion thereof against one another.

2. The vehicle according to claim 1, wherein the upper-body airbags are each pivotable via an airbag unit which is pivotally connected to the lying device.

3. The vehicle according to claim 1, wherein each airbag unit is pivotable via at least one actuator.

4. The vehicle according to claim 1, wherein the airbag units are pivotable at least between a release position and a contact position, each airbag unit being arranged in a pivoted position laterally of the lying device and an exit region of the upper-body airbag from the airbag unit being directed toward a lying side of the lying device in the release position.

5. The vehicle according to claim 1, wherein the airbag units are pivotable at least between a non-use position and the release position, each airbag unit being arranged in a pivoted position on an underside of a support structure of the lying device that is opposite the lying side and being covered by the support structure from the lying side in the non-use position.

6. The vehicle according to claim 1, wherein the upper-body airbags are transferred into their release state in the contact position, the airbag units being arranged, when in the contact position, in a pivoted position which is pivoted further in the direction of the lying side of the lying device compared to the release position so that a force exerted on the person by the upper-body airbags in the contact position is increased compared to a force exerted on the person in the release position by the upper-body airbags that are in the release state.

7. The vehicle according to claim 1, wherein an opening or a weakened portion is formed in an upholstery element of the lying device, which is aligned with the exit region of the airbag units arranged in the release position, and an opening can be formed from the weakened portion by the upper-body airbag of the airbag unit transitioning into its release state, the upper-body airbag of the airbag unit aligned with the opening or weakened portion passing through the opening in the release state.

8. The vehicle according to claim 1, wherein an inflator of at least one of the upper-body airbags is arranged in a fixed position on the lying device and is fluidically connected to the upper-body airbag via at least one gas line.

9. The vehicle according to claim 1, wherein a longitudinal edge region of an upholstery element of the lying device covers the exit region of airbag units arranged in the release position, the edge region being transferred to a central region of the upholstery element by the transition of an upper-body airbag into its release state and/or pivoting of the airbag unit comprising the upper-body airbag-into the contact position, in the release state and/or the contact position.

10. The vehicle according to claim 1, wherein a weakened portion is formed in the upholstery element at the transition from the edge region to the central region of the upholstery element.

11. The vehicle according to claim 2, wherein each airbag unit is pivotable via at least one actuator.

12. The vehicle according to claim 2, wherein the airbag units are pivotable at least between a release position and a contact position, each airbag unit being arranged in a pivoted position laterally of the lying device and an exit region of the upper-body airbag from the airbag unit being directed toward a lying side of the lying device in the release position.

13. The vehicle according to claim 3, wherein the airbag units are pivotable at least between a release position and a contact position, each airbag unit being arranged in a pivoted position laterally of the lying device and an exit region of the upper-body airbag from the airbag unit being directed toward a lying side of the lying device in the release position.

14. The vehicle according to claim 2, wherein the airbag units are pivotable at least between a non-use position and the release position, each airbag unit being arranged in a pivoted position on an underside of a support structure of the lying device that is opposite the lying side and being covered by the support structure from the lying side in the non-use position.

15. The vehicle according to claim 3, wherein the airbag units are pivotable at least between a non-use position and the release position, each airbag unit being arranged in a pivoted position on an underside of a support structure of the lying device that is opposite the lying side and being covered by the support structure from the lying side in the non-use position.

16. The vehicle according to claim 4, wherein the airbag units are pivotable at least between a non-use position and the release position, each airbag unit being arranged in a pivoted position on an underside of a support structure of the lying device that is opposite the lying side and being covered by the support structure from the lying side in the non-use position.

17. The vehicle according to claim 2, wherein the upper-body airbags are transferred into their release state in the contact position, the airbag units being arranged, when in the contact position, in a pivoted position which is pivoted further in the direction of the lying side of the lying device compared to the release position so that a force exerted on the person by the upper-body airbags in the contact position is increased compared to a force exerted on the person in the release position by the upper-body airbags that are in the release state.

18. The vehicle according to claim 3, wherein the upper-body airbags are transferred into their release state in the contact position, the airbag units being arranged, when in the contact position, in a pivoted position which is pivoted further in the direction of the lying side of the lying device compared to the release position so that a force exerted on the person by the upper-body airbags in the contact position is increased compared to a force exerted on the person in the release position by the upper-body airbags that are in the release state.

19. The vehicle according to claim 4, wherein the upper-body airbags are transferred into their release state in the contact position, the airbag units being arranged, when in the contact position, in a pivoted position which is pivoted further in the direction of the lying side of the lying device compared to the release position so that a force exerted on the person by the upper-body airbags in the contact position is increased compared to a force exerted on the person in the release position by the upper-body airbags that are in the release state.

20. The vehicle according to claim 5, wherein the upper-body airbags are transferred into their release state in the contact position, the airbag units being arranged, when in the contact position, in a pivoted position which is pivoted further in the direction of the lying side of the lying device compared to the release position so that a force exerted on the person by the upper-body airbags in the contact position is increased compared to a force exerted on the person in the release position by the upper-body airbags that are in the release state.
